(19) United States
(12) Patent Application Publication
(10) Pub. No.: US 2008/0113269 A1
(43) Pub. Date: May 15, 2008

(54) Negative Electrode Material For Lithium Secondary Battery, Negative Electrode Using The Material, Lithium Secondary Battery Using The Negative Electrode, And Manufacturing Method Of Negative Electrode Material

(76) Inventors: Teruaki Yamamoto, Osaka (JP); Toshitada Sato, Osaka (JP); Yasuhiko Bito, Osaka (JP)

Correspondence Address: MCDERMOTT WILL & EMERY LLP, 600 13TH STREET, N.W., WASHINGTON, DC, 20005-3096, US

(21) Appl. No.: 10/584,776

(22) PCT Filed: Jan. 6, 2006
(86) PCT No.: PCT/JP06/00058

§ 371 Date: Jun. 28, 2006

(30) Foreign Application Priority Data
Jan. 11, 2005 (JP) 2005-003579

(51) Int. Cl. H01M 4/58; B05D 5/12

(52) U.S. Cl. 429/231.4; 429/231.8; 429/218.1; 252/182.1; 29/623.1; 427/122

(57) ABSTRACT

In a negative electrode material for lithium secondary batteries, basic material particles include one of phase A having silicon as a main component, and a mixed phase of phase B including an intermetallic compound of a transition metal element and silicon and the phase A. The phase A or the mixed phase is microcrystalline or amorphous. A carbon material is adhered to surfaces of the basic material particles, and a film containing a silicon oxide is formed on remained surface portions.

### RELATED APPLICATIONS

This application is the U.S. National Phase under 35 U.S.C. § 371 of International Application No. PCT/JP2006/300058, filed on Jan. 6, 2006, which in turn claims the benefit of Japanese Application No. 2005-003579, filed on Jan. 11, 2005, the disclosures of which Applications are incorporated by reference herein.

### TECHNICAL FIELD

The present invention relates to a negative electrode material for lithium secondary batteries and a manufacturing method of the material, a negative electrode using the negative electrode material, and a lithium secondary battery using the negative electrode.

### BACKGROUND ART

A lithium secondary battery that is used for a main power source of mobile communication devices and mobile electronic devices has features of high electromotive force, and high energy density. A battery using a carbon material that can store and emit lithium ions as a negative electrode material in place of lithium metal is now practiced. However, the carbon material represented by graphite is limited in the amount of lithium ions that can be stored, and theoretical capacity density of the material is 372 mAh/g, which is about 10% of theoretical capacity density of lithium metal.

Thus, in order to increase capacity of the lithium secondary battery, a material containing silicon is noticed as a negative electrode material having larger theoretical capacity density than that of the carbon material. The theoretical capacity density of silicon is 4199 mAh/g, which is large compared with lithium metal as well as graphite.

However, in crystal silicon, when it stores lithium ions during charge, change in volume 4.1 times at the maximum is induced due to expansion. When the silicon is used as an electrode material, the silicon is pulverized due to strain caused by the change in volume, consequently the electrode structure is broken. Therefore, a charge and discharge cycle characteristic is extremely bad compared with a lithium secondary battery in the related art. In addition, since electron conductivity of silicon itself is low, a high-rate discharge characteristic is also extremely bad compared with the lithium secondary battery in the related art. Furthermore, most of lithium that is stored by silicon and reduced reacts violently with oxygen to form a compound of lithium and oxygen. Therefore, lithium ions that cannot return to a positive electrode during charge are increased, resulting in large irreversible capacity. Thus, the battery capacity is not as large as expected.

Various measures have been investigated for the above problem, which are for suppressing cracks of an alloy material during expansion and contraction, and thus improving deterioration of a current controlling network that is a main factor of reduction of the charge and discharge cycle characteristic. For example, in U.S. Pat. No. 6,090,505 and Japanese Patent Unexamined Publication No. 2004-103340, a configuration containing a solid phase A and a solid phase B having compositions different from each other is disclosed as the negative electrode material. At least a part of the solid phase A is covered with the solid phase B. The solid phase A is an alloy material containing silicon, tin, zinc and the like, and the solid phase B is an alloy material containing a group 2A element, a transition element, a group 2B element, a group 3B element, a group 4B element and the like. In this case, the solid phase A is preferably amorphous or microcrystalline. However, when the negative electrode is formed from only such active materials, the irreversible capacity cannot be substantially suppressed.

PCT Patent Publication No. 00/017,949 proposes a measure that an inert gas represented by argon gas is used for an atmosphere during preparing a material particle and a surface of the particle is covered with a thin and stable film of a silicon oxide or fluoride. Thus, the amount of oxygen in a silicon material can be controlled. In such an active material, since a film formed of the silicon oxide or fluoride is thin, a side reaction of the active material with an electrolytic solution proceeds during forming a battery. Therefore, it has a small effect on reduction in irreversible capacity.

Japanese Patent Unexamined Publication No. 10-83834 discloses a method where lithium metal corresponding to the irreversible capacity is attached to a surface of the negative electrode. In addition, a method is disclosed in which the lithium metal and the negative electrode are electrically connected via a lead to prevent insufficient dissolution of the lithium metal. Furthermore, a method is proposed in which the lithium metal is set in a bottom to reduce time required for storage of lithium ions. However, in such methods, large amount of lithium is necessary for solving the above problem, which is not practical.

### SUMMARY OF THE INVENTION

In a negative electrode material for lithium secondary batteries of the present invention, basic material particles include phase A having silicon as a main component, or a mixed phase of phase B including an intermetallic compound of a transition metal element and silicon and the phase A. The basic material particles are microcrystalline or amorphous. A carbon material is adhered to surfaces of the basic material particles, and a film containing a silicon oxide is formed on remained surface portions. A manufacturing method of the negative electrode material for lithium secondary batteries of the present invention has a step of forming the basic material particles that include the phase A having silicon as the main component, or the mixed phase of the phase B including the intermetallic compound of the transition metal element and silicon and the phase A, and are in a microcrystalline region or an amorphous region; a step of adhering the carbon material to at least a part of the surfaces of the basic material particles; and a step of covering the remained portions of the surfaces of the basic material particles with the film containing the silicon oxide. A lithium secondary battery using the negative electrode material having such a structure has an excellent charge and discharge cycle characteristic and small irreversible capacity, and has significantly high capacity compared with the lithium secondary battery in the related art using the carbon material for the negative electrode material.

### BRIEF DESCRIPTION OF THE DRAWINGS

FIG. 1A is a conceptual diagram showing a first step in a manufacturing method of a negative electrode material for lithium secondary batteries according to an exemplary embodiment of the present invention;

FIG. 1B is a conceptual diagram showing a second step in the manufacturing method of the negative electrode material for lithium secondary batteries according to the exemplary embodiment of the present invention;

FIG. 1C is a conceptual diagram showing a third step in the manufacturing method of the negative electrode material for lithium secondary batteries according to the exemplary embodiment of the present invention;

FIG. 1D is a conceptual diagram showing a condition after charge and discharge of the negative electrode material for lithium secondary batteries according to the exemplary embodiment of the present invention;

FIG. 2A is a conceptual diagram showing a first step in a manufacturing method of a negative electrode material for lithium secondary batteries, the method being different from that in the exemplary embodiment of the present invention;

FIG. 2B is a conceptual diagram showing a second step in the manufacturing method of the negative electrode material for lithium secondary batteries, the method being different from that in the exemplary embodiment of the present invention;

FIG. 2C is a conceptual diagram showing a third step in the manufacturing method of the negative electrode material for lithium secondary batteries, the method being different from that in the exemplary embodiment of the present invention;

FIG. 2D is a conceptual diagram showing a condition after charge and discharge of the negative electrode material for lithium secondary batteries in the manufacturing method different from that in the exemplary embodiment of the present invention;

FIG. 3 is a perspective view showing a section of a rectangular battery that is a lithium secondary battery according to the exemplary embodiment of the present invention; and

FIG. 4 is a schematic section view of a coin battery that is a lithium secondary battery according to the exemplary embodiment of the present invention.

### DETAILED DESCRIPTION OF PREFERRED EMBODIMENTS

In the present invention, a material containing silicon that is high in capacity density but large in volume expansion is used for the basic material particle; a part of a surface of the particle is adhered with a carbon material having high conductivity, and remained surface portions are covered with a film containing a silicon oxide. The film can act a protective film after construction of a battery.

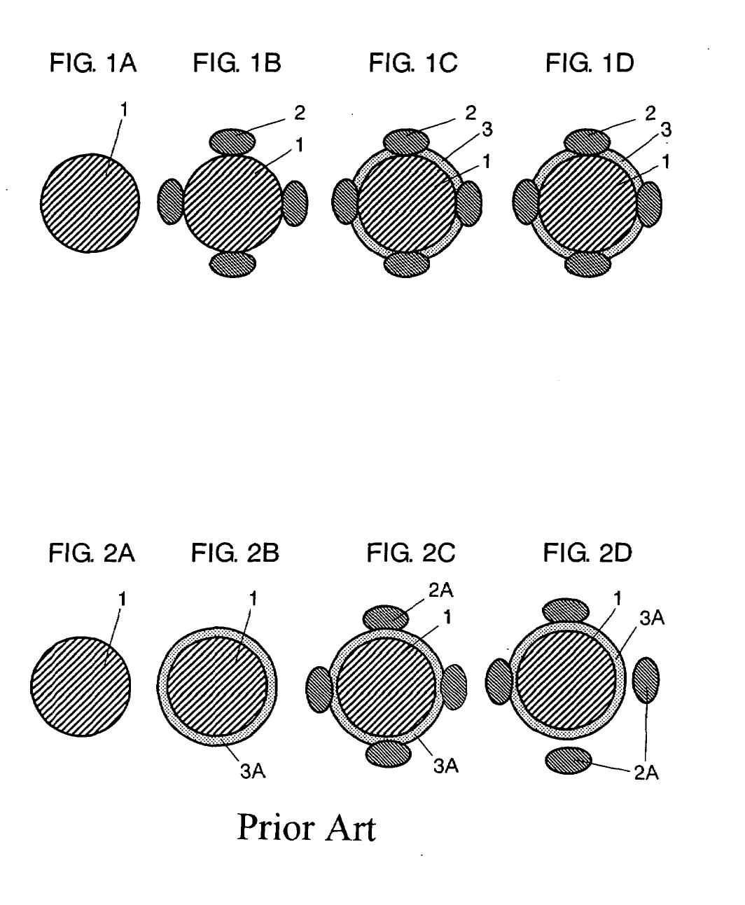

First, a manufacturing method for obtaining such a negative electrode material is described. FIGS. 1A to 1D are conceptual drawings for explaining various steps of the manufacturing method of such a negative electrode material.

FIG. 1A shows basic material particle 1 formed via a first step. Basic material particle 1 is composed of the following phase A, or a mixed phase of the phase A and phase B. The phase A contains silicon as a main component. Here, the “main component” means a component which may contain an impurity in a level of having no influence on a charge and discharge characteristic of the phase A, and such component is within a category of the present invention. The phase B is made of an intermetallic compound of a transition metal element and silicon. In the first step, basic material particle 1 configured by the phase A, or the mixed phase of the phase A and the phase B is microcrystalline or amorphous.

In a second step, as shown in FIG. 1B, carbon material 2 is adhered to the surface of basic material particle 1. In a third step, as shown in FIG. 1C, film 3 containing a silicon oxide is formed on a portion other than portions, to which carbon material 2 has been adhered, of the surface of basic material particle 1. FIG. 1D shows a condition after charge and discharge of the negative electrode material after forming a lithium secondary battery.

When the negative electrode material is manufactured in this way, since carbon material 2 is directly adhered to a part of the surface of basic material particle 1, certain conductivity is secured. Moreover, as shown in FIG. 1D, separation of carbon material 2 from basic material particle 1 after charge and discharge is suppressed. Furthermore, film 3 containing the silicon oxide covers the portion of the surface of basic material particle 1, the portion being other than the portions to which carbon material 2 is adhered; thereby basic material particle 1 is prevented from being directly contacted to the air or an electrolytic solution. Therefore, the irreversible capacity of the lithium secondary battery is reduced.

Carbon material 2 is directly adhered to the surface of basic material particle 1 including the material containing silicon so as to add conductivity to basic material particle 1, thereby volume expansion of basic material particle 1 is reduced. While an operation principle of this phenomenon is not clear, it may be considered to be in conjunction with a fact that electron conductivity of basic material particle 1 is greatly improved due to presence of carbon material 2, and thus lithium ions are smoothly stored and emitted. To allow the particle of the negative electrode material to exhibit such operation, the particle needs to be in a configuration as shown in FIG. 1C.

FIGS. 2A to 2D are views schematically showing a configuration and a manufacturing method of a negative electrode material of a lithium secondary battery different from that in the exemplary embodiment of the present invention. FIG. 2A shows basic material particle 1 similar to that shown in FIG. 1A. FIG. 2B shows a condition after a step of covering the whole surface of basic material particle 1 with film 3A containing the silicon oxide. FIG. 2C shows a condition after a step of adhering carbon material 2A to a part of a surface of film 3 containing the silicon oxide. FIG. 2D shows a condition after a lithium secondary battery to which the negative electrode material formed in this way is applied has been subjected to charge and discharge.

In the condition shown in FIG. 2C, carbon material 2A is not directly adhered to basic material particle 1. Therefore, conductivity is hardly secured. In addition, carbon material 2A tends to be separated after charge and discharge as shown in FIG. 2D. Accordingly, even if film 3A containing the silicon oxide, which can become a protective film after formation of a battery, covering the whole surface of basic material particle 1, the charge and discharge cycle characteristic of the lithium secondary battery is not improved.

As shown in FIG. 1C, basic material particle 1 needs to be covered not only with carbon material 2 but also with film 3 containing the silicon oxide. Since the surface of basic material particle 1 is highly active, violent side reaction of the surface with the electrolytic solution is induced after formation of the battery, causing large irreversible capacity. Therefore, film 3 that is dense and does not degrade ion conductivity needs to be provided.

A material containing silicon forming basic material particle 1 desirably includes the phase A containing silicon as the main component, and the phase B including the intermetallic compound of the transition metal element and silicon. As the transition metal forming the phase B, chromium (Cr), manganese (Mn), iron (Fe), cobalt (Co), nickel (Ni), cupper (Cu), molybdenum (Mo), silver (Ag), titanium (Ti), zirconium (Zr), hafnium (Hf), tungsten (W) and the like are given. Among them, an intermetallic compound of Ti and Si (TiSi₂ and the like) is preferable because of high electron conductivity. Furthermore, basic material particle 1 including at least two phases of the phase A and the phase B is preferable in the light that increase in capacity and suppression of volume expansion can be realized.

The phase A and the phase B forming basic material particle 1 are desirably composed of a microcrystalline or amorphous regions. That is, when basic material particle 1 is configured by only the phase A, the phase A desirably is desirably composed of the microcrystalline or amorphous region. When basic material particle 1 is configured by the phase A and the phase B, both of the phase A and the phase B are desirably composed of the microcrystalline or amorphous regions. The amorphous state means a state that in X-ray diffraction analysis using the CuK_{α} ray, a diffraction image (diffraction pattern) of a material does not have a clear peak attributed to a crystal face, and only a broad diffraction image is obtained. The microcrystalline state means a state that crystallite size is 50 nm or less. While the states can be obtained through direct observation by a transmission electron microscope (TEM), it can also be obtained by using Scherrer equation from half value in width of a peak obtained by the X-ray diffraction analysis. When the crystallite size is more than 50 nm, mechanical strength of the particle cannot follow change in volume during charge and discharge, causing a crack in the particle. Thus, a current collection condition tends to be degraded, which may induce deterioration in charge and discharge efficiency and deterioration in charge and discharge cycle characteristic.

As carbon material 2 directly adhered to basic material particle 1, graphite carbon such as natural graphite and artificial graphite, and amorphous carbon such as acetylene black (hereinafter, mentioned as AB) and Ketjein black (hereinafter, mentioned as KB) are given. Among them, the graphite carbon material that can store and emit lithium ions is preferable in the light of increasing capacity of the negative electrode material. In the light of improving electron conductivity between basic material particles 1, carbon material 2 desirably contains a fibrous carbon material such as carbon nanofiber, carbon nanotube, and vapor grown carbon fiber. Here, “fibrous” means that an aspect ratio of a major axis to a minor axis is 10:1 or more.

Film 3 is preferably at least 0.05 wt % and at most 5.0 wt % per silicon element in terms of the amount of oxygen, and more preferably at least 0.1 wt % and at most 1.0 wt %. When film 3 is less than 0.05 wt % in terms of the amount of oxygen, the side reaction between basic material particle 1 and the electrolytic solution after formation of the battery is hard to be suppressed, resulting in increase in irreversible capacity. Conversely, when it is more than 5.0 wt % in terms of the amount of oxygen, since ion conductivity directed to basic material particle 1 is greatly reduced, influence of reaction of oxygen in film 3 containing the silicon oxide with lithium ions is greater, resulting in increase in irreversible capacity.

A covering level of film 3 on basic material particle 1 can be controlled by changing the amount of carbon material 2 to be added. While an adhesion mode of carbon material 2 to basic material particle 1 depends on a shape of carbon material 2, generally, it inconsistently relates to a formation mode of film 3. That is, film 3 is not formed on portions where carbon material 2 is adhered. Specifically, to make the covering amount of film 3 to be within the above range in terms of the amount of oxygen, the adhesion amount of carbon material 2 is controlled to be 1.9 wt % to 18 wt %. When the adhesion amount of carbon material 2 is less than 1.9 wt %, film 3 becomes too much, resulting in reduction in conductivity between particles. Conversely, when the adhesion amount of carbon material 2 is more than 18 wt %, film 3 becomes too little, resulting in increase in side reaction between basic material particle 1 and the electrolytic solution.

Specific surface area of basic material particle 1 is preferably at least 0.5 m²/g and at most 20 m²/g. When the area is less than 0.5 m²/g, a contact area to the electrolytic solution is decreased, resulting in reduction in efficiency of charge and discharge; and when it is more than 20 m²/g, reactivity with the electrolytic solution becomes excessive, resulting in increase in irreversible capacity. Mean particle size of basic material particle 1 is preferably within a range of 0.1 μm to 10 μm. When the particle size is less than 0.1 μm, since the surface area is large, reactivity with the electrolytic solution becomes excessive, resulting in increase in irreversible capacity. When it is more than 10 μm, since the surface area is small, the contact area to the electrolytic solution is decreased, resulting in reduction in efficiency of charge and discharge.

As the method of forming basic material particle 1 as the first step, a method of directly synthesizing it by mechanical grinding and mixing using a ball mill, a vibration mill machine, a planetary ball mill and the like (mechanical alloying method) is given. Among them, use of the vibration mill machine is most preferable in the light of throughput.

As a method of adhering carbon material 2 to at least a part of the surface of basic material particle 1, as the second step, the following method is given. That is, mechanical energy mainly including compression force and/or milling force is exerted between basic material particle 1 and carbon material 2 by using a compression milling micro-grinder. Thus, carbon material 2 is pressed and adhered to the surface of basic material particle 1. In this way, a method of using a mechanochemical reaction can be used. As specific methods, a hybridization method, a mechanofusion method, a theta composer method, the mechanical alloying method as mentioned above and the like are given. Among them, the mechanical alloying method using the vibration mill machine is preferable because of advantages that a strong interface can be formed without causing the side reaction on the surface of basic material particle 1 having comparatively high activity, in addition, continuous processing from the first step can be performed. As an example of the vibration mill machine, a vibration ball mill machine FV-20 manufactured by CHUO KAKOHKI CO., LTD is given.

As a method of forming film 3 containing the silicon oxide on the remained surface portions of basic material particle 1 as the third step, a method of gradually introducing oxygen into a closed container having an agitation function can be used. In particular, when a material has limitation in temperature, equipping of a heat radiation mechanism such as water-cooling jacket is further preferable because increase in temperature of the material is suppressed and thus processing time is shortened. Specifically, a method of using a vibration dryer or kneader is given.

The first to third steps are preferably performed in an inert atmosphere or an atmosphere containing an inert gas in the light of avoiding excessive oxidation. Argon gas is preferably used because nitrogen may cause formation of silicon nitrides.

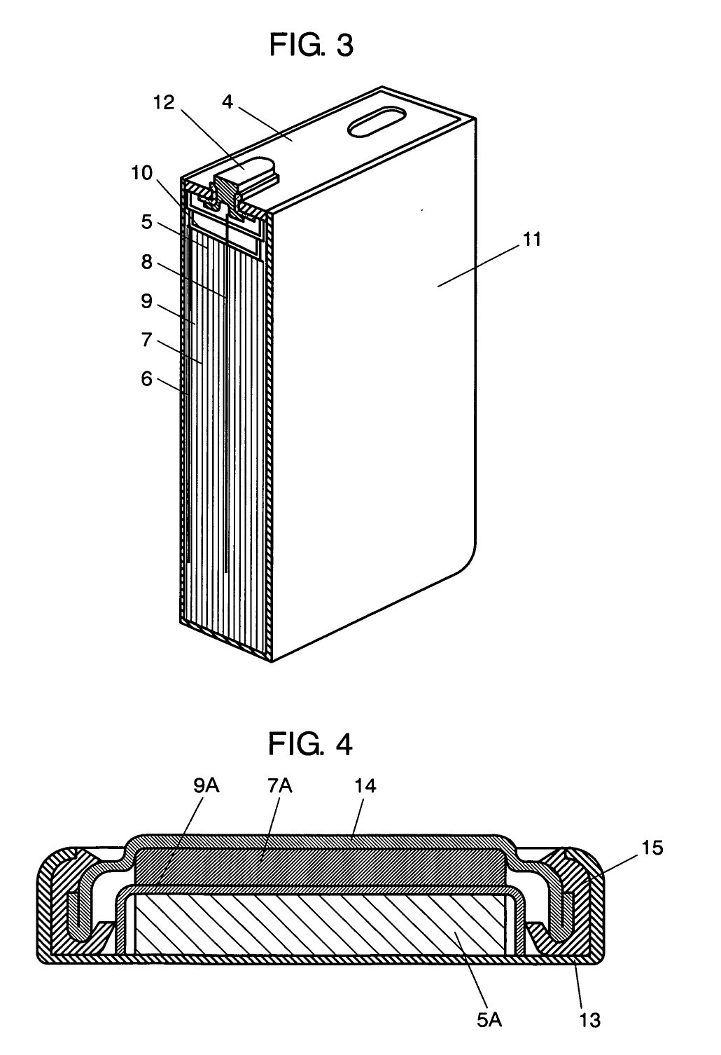

Next, a configuration of the lithium secondary battery according to the exemplary embodiment of the present invention is described in detail. FIG. 3 is a perspective view showing a section of a rectangular battery as the lithium secondary battery according to the exemplary embodiment of the present invention.

Positive electrode 5 is connected with positive electrode lead 6, and negative electrode 7 is connected with negative electrode lead 8. Positive electrode 5 and negative electrode 7 are combined via separator 9, and stacked or wound such that a lateral section is in an approximately elliptic pattern. These are inserted into rectangular metal case 11. Positive electrode lead 6 is connected to seal plate 4 electrically connected to metal case 11. Negative electrode lead 8 is connected to negative electrode terminal 12 attached to seal plate 4. Negative electrode terminal 12 is electrically isolated from seal plate 4. Insulative frame 10 is disposed below seal plate 4 to prevent negative electrode lead 8 from touching metal case 11 or seal plate 4. Furthermore, an electrolytic solution prepared by dissolving a supporting salt in an organic solvent is poured, then an opening (not shown) of metal case 11 is sealed by seal plate 4, thereby the rectangular lithium secondary battery is formed.

FIG. 4 is a schematic sectional view of a coin-shaped battery as the lithium secondary battery according to the exemplary embodiment of the present invention. Negative electrode 7A is pressed with a lithium foil to a surface at a side of separator 9A for use. Positive electrode 5A and negative electrode 7A are stacked via porous separator 9A mainly including a polypropylene nonwoven fabric. This stack is pinched by positive electrode can 13 and negative electrode can 14 which are electrically isolated by gasket 15. The electrolytic solution prepared by dissolving the supporting salt in the organic solvent is poured into at least one of positive electrode can 13 and negative electrode can 14, and then the cans are sealed, thereby the coin-shaped lithium secondary battery is formed.

Negative electrodes 7, 7A contain the negative electrode material and a binding agent. As the binding agent, polyacrylic acid (hereinafter, mentioned as PAA), styrene-butadiene copolymer or the like is used. In addition to this, negative electrodes 7, 7A may be configured by mixing a conductive agent and the binding agent to the negative electrode material. As the conductive agent, fibrous or scaly small-graphite, carbon nanofiber, carbon black or the like can be used. As the binding agent, PAA or polyimide can be used. These materials are kneaded using water or an organic solvent, and then the kneaded materials are coated on a metal foil mainly including copper and dried, and then roll-pressed as necessary, and then cut into a predetermined size for use, thereby negative electrode 7A is obtained. Alternatively, the materials are granulated in a kneading process or a spray dry process using water or an organic solvent, and then molded into a pellet form in a predetermined size, and then dried for formation, thereby negative electrode 7A is obtained.

Positive electrodes 5, 5A contain a lithium compound oxide as a positive electrode material (active material), the binding agent, and the conductive agent. As the active material, LiCoO₂ and the like are used for positive electrode 5, and Li_{0.55}MnO₂, Li₄Mn₅O₁₂, Li₂Mn₄O₉ or the like is used for positive electrode 5A. As the binding agent, fluorine resin such as polyvinylidene-fluoride (hereinafter, mentioned as PVDF) can be used. As the conductive agent, AB or KB can be used. The materials are kneaded using water or the organic solvent, and then the kneaded materials are coated on a foil mainly including aluminum and dried. This intermediate product is cut into a predetermined size after roll-pressing. In this way, positive electrode 5 is obtained. Positive electrode 5A is configured by granulating the active material, the conductive agent such as small graphite or carbon black, and the binding agent in the kneading process and the like using the water or the organic solvent, then molding them into a pellet form in a predetermined size and then drying.

### First Exemplary Embodiment

Hereinafter, advantages of the present invention are described using a specific example. First, a first exemplary embodiment of the present invention using the rectangular battery as shown in FIG. 3 is described. Preparation of a sample LE1 is first described.

A negative electrode material was synthesized as follows. Silicon powder and titanium powder were mixed such that an element molar ratio is 94.4:5.6. This mixed powder of 1.2 kg and stainless balls of 1 inch in diameter of 300 kg were inputted into a vibration ball mill machine. An atmosphere in the machine was substituted by argon gas, and then the powder was subjected to grinding treatment for 60 hours at amplitude of 8 mm and frequency of 1200 rpm. In this way, basic material particles 1 including Si—Ti (phase B) and Si (phase A) were obtained. It was confirmed from TEM observation of basic material particles 1 that crystallite 50 nm or less in size occupied at least 80% of the whole crystallite. When it was assumed that Ti was wholly formed into TiSi₂, a weight ratio of the phase B to the phase A was 1:4.

Next, AB as carbon material 2 was put into a closed container, then subjected to vacuum drying for 10 hours at 180° C., and then an atmosphere in the container was substituted by argon gas. The dried AB in a ratio of 9.5 wt % to a charged silicon amount in basic material particles 1 was put into a vibration ball mill machine while being kept in the argon gas atmosphere. The machine was then operated for 30 min at amplitude of 8 mm and frequency of 1200 rpm for adhesion treatment of carbon material 2. After the treatment, basic material particles 1 adhered with carbon material 2 were collected into a vibration dryer while being kept in the argon gas atmosphere. A mixed gas of argon and oxygen was intermittently introduced in 1 hour such that material temperature did not exceed 100° C. while being agitated. In this way, film 3 containing the silicon oxide was formed on surface portions other than surface portions to which carbon material 2 was adhered (slow oxidation treatment). The amount of oxygen in film 3 was 0.2 wt % per silicon element.

Next, a preparation method of negative electrode 7 is described. The negative electrode material obtained as above, massive graphite, and PAA as the binding agent were sufficiently mixed. Such a mixture was mixed with ion-exchanged water having a decreased amount of dissolved-oxygen by bubbling nitrogen for 30 minutes; consequently a negative electrode paste was obtained. A weight ratio of these materials contained in the negative electrode paste was set to be basic material particle 1:massive graphite:PAA=20:80:5. The obtained negative electrode paste was coated on both sides of a cupper foil of 15 μm in thickness, then subjected to predrying for 15 minutes at normal pressures and 60° C., consequently a crude product of negative electrode 7 was obtained. The crude product was roll-pressed, then further subjected to vacuum drying for 10 hours at 180° C., consequently negative electrode 7 was obtained. Negative electrode 7 was formed in an argon atmosphere so that the slow oxidation condition of basic material particles 1 was kept.

Next, a formation method of positive electrode 5 is described. LiCoO₂ as a positive electrode material was synthesized by mixing Li₂CO₃ and CoCO₃ in a predetermined molar ratio and then heating at 950° C. Then, the synthesized LiCoO₂ was classified. LiCoO₂ having a particle size of 100 mesh or lower was used. AB of 10 weight part as the conductive agent, polytetrafluoroethylene of 8 weight part as the binding agent, and appropriate amount of pure water were added to the positive electrode material of 100 weight part, then sufficiently mixed, consequently a positive electrode mixture paste was obtained. The paste was coated on both sides of a current collector made of an aluminum foil, then dried and then roll-pressed, and then cut into a predetermined size, consequently positive electrode 5 was obtained.

Next, a production procedure of a battery is described. Aluminum positive electrode lead 6 was attached to positive electrode by ultrasonic welding, and copper negative electrode lead 8 was similarly attached to negative electrode 7. Then, positive electrode 5 and negative electrode 7 were stacked with separator 9 being interposed therebetween, and the stack was wound in a flat shape, consequently an electrode group was obtained. For separator 9, a belt like, polypropylene porous film which was wider than positive electrode 5 and negative electrode 7 was used.

The electrode group was inserted into rectangular metal case 11 while a polypropylene insulating plate (not shown) was disposed under the electrode group, and frame 10 was disposed on the electrode group. Negative electrode lead 8 was connected to a back of seal plate 4, and positive electrode lead 6 was connected to a positive electrode terminal (not shown) provided in the center of seal plate 4. After that, seal plate 4 was welded to an opening of metal case 11. Then, an electrolytic solution prepared by dissolving LiPF₆ of 1.0 mol/dm³ in a mixed solvent of ethylene carbonate (EC) and diethyl carbonate (volume ratio of 1:3) was poured from a pouring port provided in seal plate 4. After that, the pouring port was closed by a plug, consequently a battery of the sample LE1 was produced, having width of 30 mm, height of 48 mm, thickness of 5 mm, and designed battery capacity of 1000 mAh. The battery was also produced in the argon atmosphere in order to keep the slow oxidation condition of basic material particles 1.

In a sample LC1 for comparison, the treatment of adhering carbon material 2 to basic material particles 1 was not performed, and carbon material 2 was merely mixed to basic material particles 1. Except for this, a battery similar to the sample LE1 was produced. In a sample LC2 for comparison, the treatment of adhering carbon material 2 was performed after covering basic material particles 1 with film 3 containing the silicon oxide in production of the sample LE1. Scaly artificial graphite was used as carbon material 2 to be adhered to basic material particles 1. Except for this, a battery similar to the sample LE1 was produced. Furthermore, in a sample LC3 for comparison, basic material particles 1 was not covered with film 3 containing the silicon oxide in production of the sample LE1. Scaly artificial graphite was used as carbon material 2 to be adhered to basic material particles 1. All steps of preparation of the negative electrode material, formation of negative electrode 7, and preparation of the battery were performed under the argon atmosphere, and transfer between the respective steps was performed under the argon atmosphere. Thus, film 3 containing the silicon oxide was substantially not formed. Except for this, a battery similar to the sample LE1 was produced.

Batteries of samples LE2 to LE5 were produced in the same way as in the sample LE1 except for a process that carbon material 2 to be adhered to basic material particles 1 was changed in production of the sample LE1. As carbon material 2, the Ketjein black was used for the sample LE2, the vapor grown carbon fiber was used for the sample LE3, the scaly artificial graphite was used for the sample LE4, and the carbon nanofiber was used for the sample LE5. These samples were used to investigate influence of a type of carbon material 2.

Batteries of samples LE6 to LE11 were produced in the same way as in the sample LE4 except for a process that the amount of carbon material 2 to be adhered to basic material particles 1 was changed in production of the sample LE4. Thus, films 3 containing the silicon oxide were set to be 0.05, 0.1, 1, 2, and 5 wt % in oxygen amount per silicon element respectively. These samples were used to investigate influence of the amount of oxygen in film 3.

A battery of a sample LE12 was produced in the same way as in the sample LE4 except that basic material particles 1 was composed of only the phase A in production of the sample LE4. On the other hand, batteries of samples LE13 to LE15 were produced in the same way as in the sample LE4 except that a weight ratio of the phase A to the phase B in basic material particles 1 was changed in production of the sample LE4. Here, the weight ratio was set on the assumption that all Ti was formed into TiSi₂. The weight ratio of the phase A to the phase B was set to be 1:1 in the sample LE13, 2:1 in the sample LE14, and 4:1 in the sample LE15, respectively. These samples were used to investigate influence of a composition of basic material particles 1.

Batteries of samples LE16 to LE19 were produced in the same way as in the sample LE4 except that a transition metal forming the phase B is changed from Ti to Ni, Fe, Zr and W in production of the sample LE4.

The samples prepared as above were evaluated as follows. Respective batteries were charged and discharged with constant current in a condition of current of 0.2 C and cut voltage of 3.3 V during charge, and current of 2 C and cut voltage of 2.0 V during discharge in a constant-temperature chamber set at 20° C. Here, 0.2 C means current of charging designed capacity in 5 hours, and 2.0 C means current of discharging the designed capacity in 0.5 hours. Difference between initial charge capacity and initial discharge capacity was defined as the irreversible capacity, and a ratio of the irreversible capacity to charging capacity was defined as the irreversibility ratio.

Next, a charge and discharge cycle test was performed. Charge and discharge were repeated for 100 cycles in the same charge and discharge condition as the above in the constant-temperature chamber set at 20° C. At that time, a ratio of discharge capacity at the 100th cycle to discharge capacity at the first cycle was defined as the capacity retention ratio. Tables 1 to 4 show specifications and evaluation results of the respective samples.

TABLE 1

| | | Weight | Carbon | Carbon | | | | | Capacity |
|---|---|---|---|---|---|---|---|---|---|
| | Element | composition | amount | adhesion | Slow oxidation | Carbon | Irreversibility | O/Si | retention ratio |
| Sample | ratio Si:Ti | TiSi₂:Si | (wt %) | treatment | treatment | material | ratio (%) | (wt %) | (%) |
| LE1 | 94.4:5.6 | 1:4 | 9.5 | performed | Performed, | AB | 7.2 | 0.20 | 86 |
| LE2 | | | | | after adhesion | KB | 6.9 | 0.20 | 82 |
| LE3 | | | | | of carbon | Carbon fiber | 7.8 | 0.30 | 91 |
| LE4 | | | | | | Scaly graphite | 6.4 | 0.20 | 92 |
| LE5 | | | | | | Carbon | 9.3 | 0.29 | 94 |
| | | | | | | nanofiber | | | |
| LC1 | | | | Not | Performed, | AB | 13.2 | 7.12 | 71 |
| | | | | performed | after mixing of | | | | |
| | | | | (mixing only) | carbon | | | | |
| LC2 | | | | performed | Performed, | Scaly graphite | 17.5 | 8.94 | 75 |
| | | | | | before | | | | |
| | | | | | adhesion of | | | | |
| | | | | | carbon | | | | |
| LC3 | | | | | Not performed, | | 11.7 | 0.02 | 77 |
| | | | | | kept in argon | | | | |
| | | | | | atmosphere | | | | |

TABLE 2

| | | Weight | Carbon | Carbon | | | | | Capacity |
|---|---|---|---|---|---|---|---|---|---|
| | Element | composition | amount | adhesion | Slow oxidation | Carbon | Irreversibility | O/Si | retention ratio |
| Sample | ratio Si:Ti | TiSi₂:Si | (wt %) | treatment | treatment | material | ratio (%) | (wt %) | (%) |
| LE6 | 94.4:5.6 | 1:4 | 0.51 | performed | Performed, | Scaly | 9.7 | 5.00 | 81 |
| LE7 | | | 0.98 | | after adhesion | graphite | 8.8 | 2.00 | 83 |
| LE8 | | | 1.9 | | of carbon | | 8.1 | 1.00 | 85 |
| LE9 | | | 4.8 | | | | 7.2 | 0.50 | 88 |
| LE4 | | | 9.5 | | | | 6.4 | 0.20 | 92 |
| LE10 | | | 18 | | | | 6.3 | 0.10 | 90 |
| LE11 | | | 49 | | | | 7.4 | 0.05 | 84 |

TABLE 3

| | | Weight | Carbon | Carbon | | | | | Capacity |
|---|---|---|---|---|---|---|---|---|---|
| | Element | composition | amount | adhesion | Slow oxidation | Carbon | Irreversibility | O/Si | retention ratio |
| Sample | ratio Si:Ti | TiSi₂:Si | (wt %) | treatment | treatment | material | ratio (%) | (wt %) | (%) |
| LE12 | 100:0 | 0:1 | 9.5 | performed | Performed, | Scaly | 6.1 | 0.18 | 90 |
| LE4 | 94.4:5.6 | 1:4 | | | after adhesion | graphite | 6.4 | 0.20 | 92 |
| LE13 | 85.1:14.9 | 1:1 | | | of carbon | | 7.6 | 0.24 | 92 |
| LE14 | 79.4:20.6 | 2:1 | | | | | 8.3 | 0.37 | 92 |
| LE15 | 74.5:25.5 | 4:1 | | | | | 9.5 | 0.49 | 94 |

TABLE 4

| | | | Carbon | Carbon | | | | | Capacity |
|---|---|---|---|---|---|---|---|---|---|
| | Element | | amount | adhesion | Slow oxidation | Carbon | Irreversibility | O/Si | retention ratio |
| Sample | ratio | Composition | (wt %) | treatment | treatment | material | ratio (%) | (wt %) | (%) |
| LE16 | 94.4:5.6 | Si—Ni | 9.5 | performed | Performed, | Scaly | 6.5 | 0.41 | 90 |
| LE17 | | Si—Fe | | | after adhesion | graphite | 6.8 | 0.60 | 90 |
| LE18 | | Si—Zr | | | of carbon | | 6.3 | 0.32 | 91 |
| LE19 | | Si—W | | | | | 6.1 | 0.20 | 91 |

First, samples LC1 to LC3 produced for comparison are described. In the sample LC1, carbon material 2 was not adhered to basic material particles 1 and only the slow oxidation treatment was performed, and then carbon material 2 was mixed. Therefore, the amount of oxygen to the silicon element reached to 7.12 wt %. As a result, the irreversibility ratio of a battery was increased to 13.2%, consequently battery capacity was decreased. In the sample LC2, carbon material 2 was adhered after the slow oxidation treatment of basic material particles 1. Therefore, the amount of oxygen to the silicon element reached to 8.94 wt %, and the irreversibility ratio of a battery was increased to 17.5% similarly to the sample LC1, consequently battery capacity was significantly decreased. Furthermore, in the sample LC3, film 3 containing the silicon oxide was not formed. Therefore, basic material particles 1 were corroded by the electrolytic solution after formation of the battery, consequently the capacity retention ratio was decreased.

On the other hand, all the samples LE1 to LE5 were reduced in irreversible capacity, in addition, improved in capacity retention ratio. The reason for reduction in irreversible capacity is considered to be because the amount of oxygen to the silicon element was reduced due to adhesion of carbon material 2. The reason for improvement in capacity retention ratio is considered to be because carbon material 2 was directly adhered to a surface of a material containing silicon to add conductivity to the material, thereby volume expansion of basic material particles 1 was reduced.

In the sample LE4 and the samples LE6 to LE11, the amount of oxygen in film 3 is changed by changing the amount of carbon material 2. From Table 2 which shows evaluation results of them, it is known that the amount of oxygen is preferably 0.1 wt % to 1.0 wt % to the silicon element. That is, the adhesion amount of carbon material 2 is preferably 1.9 wt % to 18 wt %. In the sample LE11 where the amount of oxygen is less than 0.1 wt %, the irreversibility ratio is increased compared with the sample LE10. The reason for this is considered to be because of an effect of increase in surface area due to increase in amount of adhered carbon material 2. In the sample LE7 where the amount is more than 1.0 wt %, the capacity retention ratio is decreased to less than 85%. The reason for this is considered to be because the effect of reduction in volume expansion of basic material particles 1 is decreased due to decrease in amount of adhered carbon material 2.

In the sample LE4 and the samples LE12 to LE15, the composition of basic material particles 1 is changed. From Table 3 which shows evaluation results of them, the capacity retention ratio is improved in the sample LE4 and the samples LE13 to LE15, in which basic material particles 1 include the phase A and the phase B, compared with the sample LE12 in which basic material particles 1 include only the phase A. The reason for this is considered to be because increase in capacity and suppression in volume expansion can be achieved due to presence of the phase B. As shown in Table 4, the effect is similarly exhibited in the case that Ni, Fe, Zr or W is used for a transition metal species in the phase B as the samples LE16 to LE19.

### Second Exemplary Embodiment

In a second exemplary embodiment of the present invention, results of formation and investigation of the coin-shaped battery as shown in FIG. 4 are described. First, a production procedure of a sample CE1 is described.

Negative electrode 7A was formed as follows. A negative material obtained in the same way as in the sample LE4 in the first exemplary embodiment, AB as the conductive agent, and PAA as the binding agent were mixed in a ratio of 82:20:10 in a weight ratio of solid contents, so that an electrode mixture was prepared. The electrode mixture was molded in a pellet form in diameter of 4 mm and thickness of 0.3 mm, and then dried for 12 hours at 200° C. In this way, negative electrode 7A was obtained. Negative electrode 7A described above was formed in an argon atmosphere in order to keep the slow oxidation condition of basic material particles 1.

Next, a formation procedure of positive electrode 5A is described. Manganese dioxide and lithium hydroxide were mixed in a molar ratio of 2:1, and then fired for 12 hours at 400° C. in the air. In this way, Li_{0.55}MnO₂ as a positive electrode material (active material) was obtained. The positive electrode material, AB as the conductive agent, and aqueous dispersion of fluorine resin as the binding agent were mixed in 88:6:6 in a weight ratio of solid contents. This mixture was molded in a pellet form in diameter of 4 mm and thickness of 1.0 mm, and then dried for 12 hours at 250° C., consequently positive electrode 5A was obtained.

Negative electrode 7A and positive electrode 5A obtained in the above way were used to produce a battery. In assembly of the battery, negative electrode 7A was alloyed with lithium metal. Specifically, a lithium foil was pressed to a surface of negative electrode 7A (at a side where separator 9A is disposed), so that lithium was stored under presence of the electrolytic solution. In this way, a lithium alloy was electrochemically made. Separator 9A made of polypropylene nonwoven-fabric was disposed between negative electrode 7A alloyed with lithium in the above way and positive electrode 5A. In view of the irreversible capacity, the amount of the lithium foil was set such that initial discharge capacity was 7.0 mAh in deep discharge, that is, in discharge of closed circuit voltage of the battery to 0 V, and electrochemical potential of each of positive electrode 5A and negative electrode 7A to lithium was +2.0 V. When the electrochemical potential of positive electrode 5A to lithium is equal to that of negative electrode 7A, voltage as a battery becomes 0 V. Here, when the electrochemical potential of positive electrode 5A to lithium is lower than +2.0 V, positive electrode 5A is significantly deteriorated. Therefore, the amount of the lithium foil was set as above. Specifically, the amount of positive electrode 5A was set to be 41.3 mg, the amount of negative electrode 7A was set to be 4.6 mg, and the amount of the lithium foil was set to be 4.0×10⁻⁹ m³.

For the electrolyte, a mixed solvent of propylene carbonate:EC:dimethoxyethane=1:1:1 in a volume ratio was used as an organic solvent. LiN(CF₃SO₂)₂ as the supporting salt was dissolved in the mixed solvent in a ratio of 1×10⁻³ mol/m³. An electrolytic solution prepared in this way was used. The electrolytic solution of 15×10⁻⁹ m³ was filled in a battery container composed of positive electrode can 13, negative electrode can 14, and gasket 15.

Finally, positive electrode can 13 was caulked to deform and compress the gasket 15, thereby a battery of the sample CE1 was produced. The battery was produced in the argon atmosphere in order to keep the slow oxidation condition of basic material particles 1.

Batteries of samples CE2 and CE3 were produced in the same way as in the sample CE1 except that the positive electrode material was changed. Li₄Mn₅O₁₂ used for the sample CE2 was obtained by mixing manganese dioxide and lithium hydroxide in a molar ratio of 1:0.8, and then firing them for 6 hours at 500° C. in the air. Li₂Mn₄O₉ used for the sample CE3 was obtained by mixing manganese carbonate and lithium hydroxide in a molar ratio of 2:1, and then firing them for 32 hours at 345° C. in the air.

In a sample CC1 for comparison, the treatment of adhering carbon material 2 to basic material particles 1 was not performed, and carbon material 2 was merely mixed to basic material particles 1. A battery similar to the sample CE1 except for this was produced. In each of samples CC2 to CC4 for comparison, the treatment of adhering carbon material 2 was performed after covering basic material particles 1 with film 3 containing the silicon oxide in production of the samples CE1 to CE3. Batteries similar to the samples CE1 to CE3 except for this were produced. In a sample CC5 for comparison, all the steps of preparation of the negative electrode material, formation of negative electrode 7A, and battery production were performed under the argon atmosphere, and transfer between the respective steps was performed under the argon atmosphere in production of the sample CE1. Thus, film 3 containing the silicon oxide was substantially not formed. A battery similar to the sample CE1 except for this was produced.

The samples prepared as above were evaluated as follows. Respective batteries were charged and discharged with constant current of 0.05 C in a condition of cut voltage of 3.0 V during charge, and cut voltage of 2.0 V during discharge in a constant-temperature chamber set at 20° C. Here, 0.05 C means current of charging or discharging designed capacity in 20 hours. Difference between capacity of adhered lithium metal and initial discharging capacity was defined as the irreversible capacity, and a ratio of the irreversible capacity to the capacity of adhered lithium metal was defined as the irreversibility ratio.

Next, a charge and discharge cycle test was performed. Charge and discharge were repeated 100 cycles in the same charge and discharge condition as the above in the constant-temperature chamber set at 20° C. At that time, a ratio of discharge capacity at the 100th cycle to discharge capacity at the first cycle was defined as the capacity retention ratio. Table 5 shows specifications and evaluation results of the respective samples.

TABLE 5

| | | Positive | Carbon | Carbon | | | | | Capacity |
|---|---|---|---|---|---|---|---|---|---|
| | Element | electrode | amount | adhesion | Slow oxidation | Carbon | Irreversibility | O/Si | maintenance |
| Sample | ratio Si:Ti | material | (wt %) | treatment | treatment | material | ratio (%) | (wt %) | ratio (%) |
| CE1 | 94.4:5.6 | Li_{0.55}MnO₂ | 9.5 | performed | Performed, after | Scaly | 7.2 | 0.20 | 86 |
| CE2 | | Li₄Mn₅O₁₂ | | | adhesion of | graphite | 7.3 | | 85 |
| CE3 | | Li₂Mn₄O₉ | | | carbon | | 7.2 | | 88 |
| CC1 | | Li_{0.55}MnO₂ | | Not performed | Performed, after | | 13.2 | 7.04 | 71 |
| | | | | (mixing only) | mixing of carbon | | | | |
| CC2 | | | | performed | Performed, | | 17.5 | 8.94 | 75 |
| CC3 | | Li₄Mn₅O₁₂ | | | before adhesion | | 17.7 | | 74 |
| CC4 | | Li₂Mn₄O₉ | | | of carbon | | 17.6 | | 76 |
| CC5 | | Li_{0.55}MnO₂ | | | Not performed, | | 11.7 | 0.02 | 77 |
| | | | | | kept in argon | | | | |
| | | | | | atmosphere | | | | |

From comparison between the samples CE1 to CE3 and the samples CC2 to CC4, it is known that the same advantages as in the first exemplary embodiment are obtained in the coin-shaped battery. That is, the treatment of adhering carbon material 2 is performed before forming film 3 containing the silicon oxide, thereby the amount of oxygen to the silicon element is reduced, and consequently the irreversibility ratio is reduced. Furthermore, conductivity is added, thereby volume expansion of basic material particle 1 is reduced, and consequently the capacity retention ratio is improved. From comparison between the sample CE1 and the sample CC1, it is known that the treatment of adhering carbon material 2 to basic material particle 1 is necessary for reducing the irreversibility ratio. Furthermore, from comparison between the sample CE1 and the sample CC5, it is known that formation of film 3 after adhesion of carbon material 2 is necessary for improving the capacity retention ratio. These are also the same as the results in the first exemplary embodiment.

While organic electrolytic solutions were used for the electrolyte in the first and second exemplary embodiments, an electrolyte formed by gelling the organic electrolytic solutions using a gelling agent or a solid electrolyte including an inorganic or organic material may be used. A shape of the battery is not particularly limited. The invention may be applied to a cylindrical battery having an electrode group formed by winding electrodes with a long strip-shape or a flat battery configured by stacking thin electrodes in addition to the rectangular battery or the coin-shaped battery.

### INDUSTRIAL APPLICABILITY

According to the present invention, in the negative electrode for lithium secondary batteries using the high-capacity negative electrode material, the charge and discharge cycle characteristic can be improved while suppressing increase in irreversible capacity. The negative electrode can be extensively used for lithium secondary batteries for any application.

1. A negative electrode material for lithium secondary batteries, the negative electrode material being capable of storing and emitting lithium ions, comprising:
a basic material particle including one of a phase A having silicon as a main component, and a mixed phase of a phase B including an intermetallic compound of a transition metal element and silicon and the phase A, the phase A and the mixed phase being microcrystalline or amorphous,
a carbon material adhered to a part of a surface of the basic material particle, and
a film having a silicon oxide, the film being formed on a surface portion of the base material particle, the surface portion being other than a surface portion to which the carbon material is adhered.

2. The negative electrode material for lithium secondary batteries according to claim 1:
wherein the carbon material is graphite capable of storing and emitting lithium ions.

3. The negative electrode material for lithium secondary batteries according to claim 1:
wherein the carbon material is fibrous.

4. The negative electrode material for lithium secondary batteries according to claim 1:
wherein the amount of the film is at least 0.1 wt % and at most 1.0 wt % per silicon element in terms of oxygen amount.

5. The negative electrode material for lithium secondary batteries according to claim 1:
wherein an adhesion amount of the carbon material is at least 1.9 wt % and at most 18 wt %.

6. A negative electrode for lithium secondary batteries comprising the negative electrode material, the negative electrode material including:
a basic material particle including one of a phase A having silicon as a main component, and a mixed phase of a phase B including an intermetallic compound of a transition metal element and silicon and the phase A, the phase A and the mixed phase being microcrystalline or amorphous,
a carbon material adhered to a part of a surface of the basic material particle, and
a film having a silicon oxide, the film being formed on a surface portion of the base material particle, the surface portion being other than a surface portion to which the carbon material is adhered.

7. A lithium secondary battery comprising:
the negative electrode of claim 6,
a positive electrode capable of storing and emitting lithium ions, and
an electrolyte interposed between the negative electrode and the positive electrode.

8. A manufacturing method of a negative electrode material for lithium secondary batteries, the negative electrode material being capable of storing and emitting lithium ions, comprising steps of:
A) forming a basic material particle including one of a phase A having silicon as a main component, and a mixed phase of a phase B including an intermetallic compound of a transition metal element and silicon and the phase A, the phase A and the mixed phase being microcrystalline or amorphous,
B) adhering a carbon material to at least a part of a surface of the basic material particle, and
C) covering a surface portion of the base material particle by a film having a silicon oxide, the surface portion being other than a surface portion to which the carbon material is adhered.

9. The manufacturing method of the negative electrode material for lithium secondary batteries according to claim 8:
wherein the step A is performed using a vibration mill machine.

10. The manufacturing method of the negative electrode material for lithium secondary batteries according to claim 8:
wherein the step A and the step B are continuously performed using a vibration mill machine.
